(19) United States
(12) Patent Application Publication
(10) Pub. No.: US 2006/0287782 A1
(43) Pub. Date: Dec. 21, 2006

(54) System & method of filtering low order oscillation from non-rigid suspension systems

(75) Inventors: Daniel Preston, Kew Gardens, NY (US); Anthony J. Calise, Collegeville, PA (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Atair Aerospace, Inc., Brooklyn, NY (US)

(21) Appl. No.: 11/190,425

(22) Filed: Jul. 27, 2005

Related U.S. Application Data
(60) Provisional application No. 60/591,344, filed on Jul. 27, 2004.

(51) Int. Cl. G01C 23/00

(52) U.S. Cl. 701/3; 701/4

(57) ABSTRACT

A system and method of guiding an aircraft is disclosed. The aircraft includes at least one non-rigidly attached sensor for providing a signal indicative of the angular rate of turn of the aircraft. The signal includes an oscillation component and an angular rate of turn component. A filter receives the signal from the sensor and attempts to remove the oscillation component found in the signal. A guidance system provides a commanded turn rate signal. A stability augmentation system receives the filtered angular rate of turn signal and the commanded turn rate signal and processes those signals to provide an actuator command signal. The actuator command signal can best be used to control an air vehicle activation device. The method involves receiving at least one signal indicative of an angular rate of turn of the aircraft from the sensor not rigidly suspended from an aircraft, wherein the signal includes an oscillation component and an angular rate of turn component. The signal is filtered to attenuate the oscillation component while a command a turn rate signal is received. Finally, the filtered signal and the commanded turn rate signal are processed to determine an actuator command signal.

### CROSS-REFERENCE TO RELATED APPLICATIONS

This application claims the benefit of U.S. Provisional Application Ser. No. 60/591,344, filed Jul. 27, 2004.

### TECHNICAL FIELD

The present invention relates to parafoil control systems and more particularly, to the use of filters in guidance units to remove high frequency oscillations created by non-rigid suspension systems.

### BACKGROUND INFORMATION

Guided parachute systems utilize a GU (guidance unit) or AGU (automatic guidance unit) system suspended under a plurality of lines under a parafoil. The GU or AGU system typically includes an on-board flight computer (processor) that determines the position and heading of the parasail, usually based on a GPS and Inertial Navigation Sensors (INS) or the like, and outputs a turn rate command to a stability augmentation system (SAS) that follows (executes) that command. The integrated SAS sensor suite is often referred to as an attitude and heading reference system (AHRS) or inertial measurement unit (IMU), which also can be used to obtain a highly accurate indication of attitude rates. The AGU regulates the altitude and heading of the guided parachute system in such a way that it arrives at the target site (very similar to the problem of landing an aircraft at a predetermined airport).

Accuracy of current GU or AGU systems is limited as current systems can only control a parafoil under very docile flight conditions, i.e., very slow, flat turn rates. With parafoils, the bank angle and rate of descent are linked to turn rate. The angular rate of turn versus the control input of a parafoil is linear only over a short range. High performance turn rates create a severe problem for existing AGU systems and often result in out-of-control flight due to the highly nonlinear response of the parafoil at higher turn rates.

The problem stems in part from the fact that AGU or GU systems used with a parafoil are suspended by non-rigid, typically flexible, lines. These lines stretch and in fact “vibrate” under load and tension. The sensors used by the SAS to determine and regulate turn rate (typically gyros integrated with accelerometers and magnetometers) are mounted together as a part of the AGU system that is suspended from the parafoil. The suspension lines actually act like “springs” connecting the GU or AGU system to the parafoil or other air wing.

In flight, it has been found that the suspended AGU system oscillates. The exact oscillation depends on the specifics of the number of lines, suspended weight, line characteristics/properties, etc. This perhaps miniscule oscillation imposes an error into the gyroscope output with respect to what a “rigid body” turn rate would otherwise be like in the absence of the oscillations. Since the purpose of guidance and the stability augmentation system (SAS) is to regulate the turn rate of the parafoil as if it were a rigid body, the oscillations that are sensed by the SAS sensor suite is regarded as an error component that the AGU/SAS system should not respond to under ideal conditions.

Accordingly, there exists a need for an AGU/SAS system that minimizes or eliminates the effects of these oscillations. The AGU/SAS system should also preferably be compatible with guided parachute/parafoil systems. It is important to note that the present invention is not intended to be limited to a system or method which must satisfy one or more of any stated objects or features of the invention. It is also important to note that the present invention is not limited to the preferred, exemplary, or primary embodiment(s) described herein. For example, the use of the term parachute is generic and may refer to parachute, parafoil or any other fixed or non-fixed winged aircraft. Modifications and substitutions by one of ordinary skill in the art are considered to be within the scope of the present invention, which is not to be limited except by the allowed claims and their equivalents.

### SUMMARY

The present invention stems, at least in part, from the realization that the performance of a guidance unit non-rigidly suspended from an aircraft can be improved by attenuating the oscillatory errors induced by the suspension system.

According to one embodiment, the present invention features a method of guiding an aircraft. In accordance with the method, at least one signal is received as a measurement of the angular rate of turn of the aircraft from at least one sensor that is non-rigidly suspended from an aircraft. The angular rate of turn signal includes an oscillation component and an angular rate of turn component. The signal is filtered to attenuate the oscillation component. At least one commanded turn rate signal is received following which the filtered angular rate of turn signal and the at least one commanded turn rate signal are processed to determine an actuator command signal. The actuator command signal can then be used to move an actuator device from a first position to a second position which causes or effectuates a change in the flight of the aircraft.

In one embodiment, the processing of the filtered signal and at least one commanded turn rate signal is accomplished by a stability augmentation system. The stability augmentation system may include a proportional-integral-derivative (PID) controller. In another embodiment, the stability augmentation system may include an adaptive system which utilizes a neural network. The filter may include at least one linear or nonlinear filter. The filter may also consist of a multiplicity of filters that are connected in series.

The signal indicative of the angular rate of turn of the aircraft may be received from an attitude and heading reference system or an inertial measurement unit acting in unison with a global positioning system receiver.

### BRIEF DESCRIPTION OF THE DRAWINGS

These and other features and advantages of the present invention will be better understood by reading the following detailed description, taken together with the drawings wherein:

FIG. 1 is a block diagram illustrating the guidance unit and payload non-rigidly suspended from an air wing according to one embodiment of the present invention;

FIG. 2 is a flow chart illustrating the method of guiding an aircraft having a guidance unit non-rigidly suspended from an air wing according to one embodiment of the present invention;

FIG. 3 is a drawing illustrating the guidance unit non-rigidly suspended from an air wing and the payload non-rigidly suspended from the guidance unit according to one embodiment of the present invention;

FIG. 4 is a block diagram illustrating the guidance unit having at least one filter to attenuate the oscillations induced by the suspension system according to one embodiment of the present invention;

FIG. 5 is a block diagram illustrating the stability augmentation system (SAS) having a PID controller according to one embodiment of the present invention; and

FIG. 6 is a block diagram illustrating the stability augmentation system having an adaptive SAS according to one embodiment of the present invention.

### DETAILED DESCRIPTION OF THE PREFERRED EMBODIMENTS

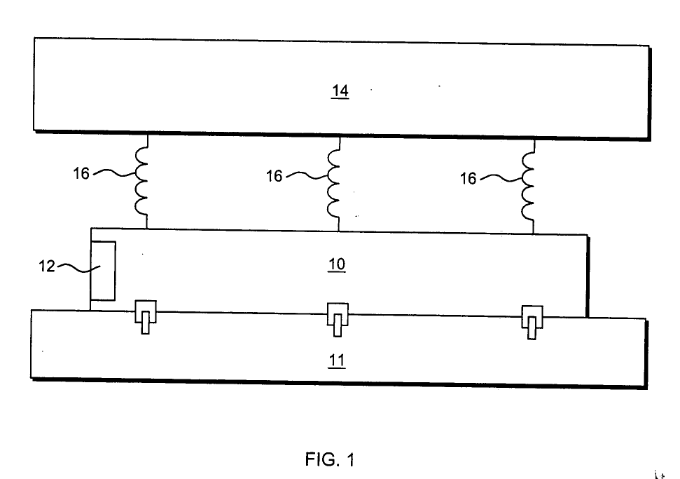

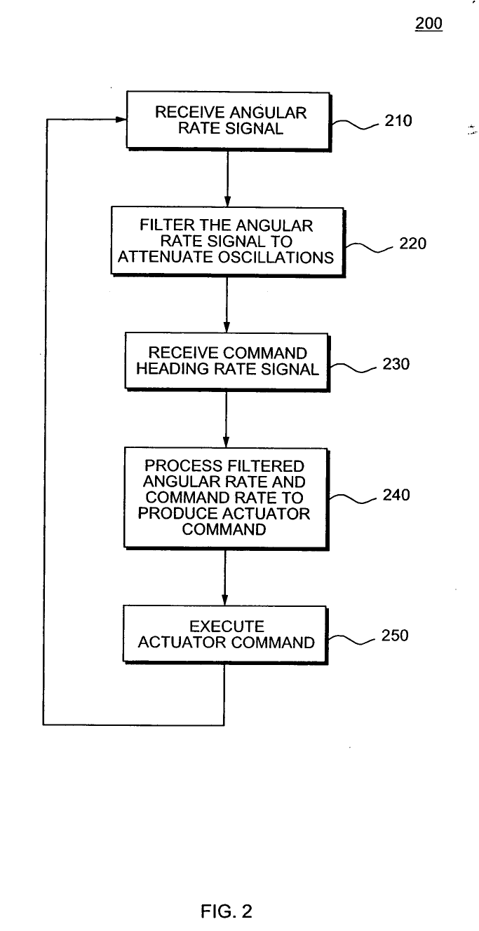

According to one embodiment, the present invention features a guidance unit (GU) system 10, FIG. 1, and method 200, FIG. 2, for controlling/guiding a payload 11 suspended from an air wing 14 by one or more non-rigid supports 16. The GU system 10 reduces the oscillation caused by the non-rigid or spring like supports 16 that is sensed by one or more of the sensors 12 (for example, but not limited to, one or more gyros, an attitude and heading reference system (AHRS) or an inertial measurement unit (IMU)) used by the GU system 10 as will be explained in greater detail herein below. Unlike a traditional airplane wherein the GU is rigidly secured to the wing or aircraft, the present invention is directed primarily to an aircraft of the type wherein the GU system 10 and the payload 11 are non-rigidly suspended from the air wing 14. The GU may be an automated guidance unit (AGU), manually operated guidance unit, or remotely operated guidance unit and the payload 11 may include a manned or unmanned payload 11. As used herein, the term air wing 14 is intended to denote a parafoil, a weight shift aircraft, paraglider, hang glider, and the like.

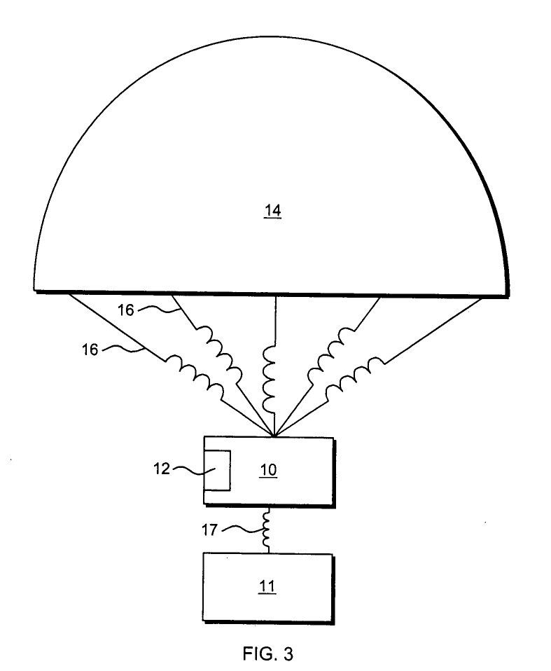

According to one embodiment, the GU system 10 is secured directly to a payload 11 as shown in FIG. 1. In this embodiment, the oscillations are caused or introduced by the non-rigid supports 16 suspending the GU system 10 and the payload 11. Alternatively, the GU system 10, FIG. 3, may be suspended from the air wing 14 by one or more non-rigid supports 16 and the payload 11 may be further suspended from the GU system 10 by a one or more non-rigid supports 17. Although the non-rigid supports 16, 17 are shown and represented in the figures as “springs”, these supports do not in fact include springs but rather they act much like springs while under tension supporting the guidance system. According to this embodiment, the oscillations sensed by the sensor 12 are typically more problematic because both sets of non-rigid supports 16, 17 induce/generate oscillations of the sensor 12.

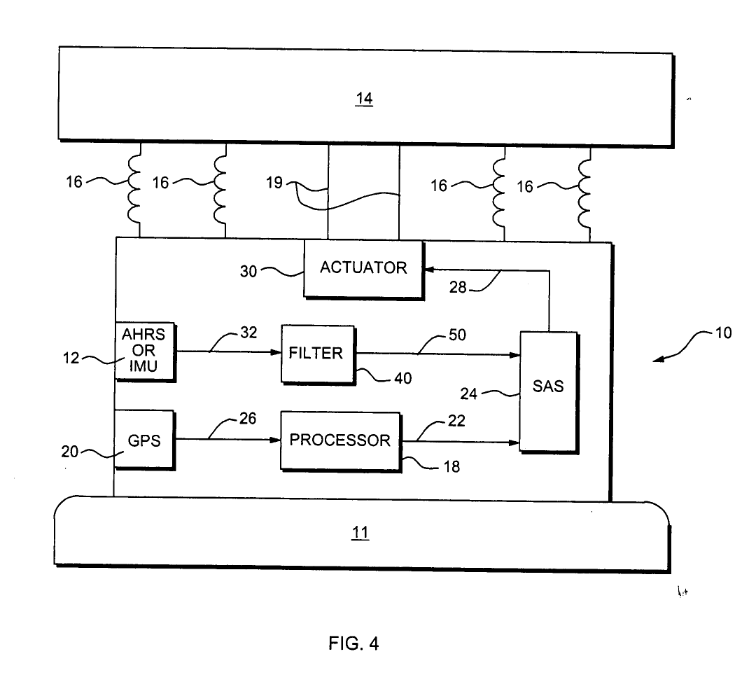

The GU system 10, FIG. 4, shown in greater detail, includes a guidance command unit 18 coupled to one or more sensors 20 (for example, a global position system receiver or the like). The guidance command unit 18 receives a sensor signal 26 from sensor(s) 20 and computes a turn rate command 22 that is derived by knowing the target site position and the present position of the parafoil/aircraft. This information is used to re-compute a desired heading at every guidance update.

The turn rate command signal 22 is output from guidance command unit 18 to a stability augmentation system (SAS) 24. As will be explained in greater detail below, the SAS 24 follows (executes) the turn rate command 22 and sends an actuator command signal 28 to an actuator/servo device 30 which controls or adjusts one or more air wing control lings 19 such that the air wing 14 follows a desired attitude or flight path, such as turn or bank, etc. The SAS 24 according to the present invention may be of any design known to those skilled in the art.

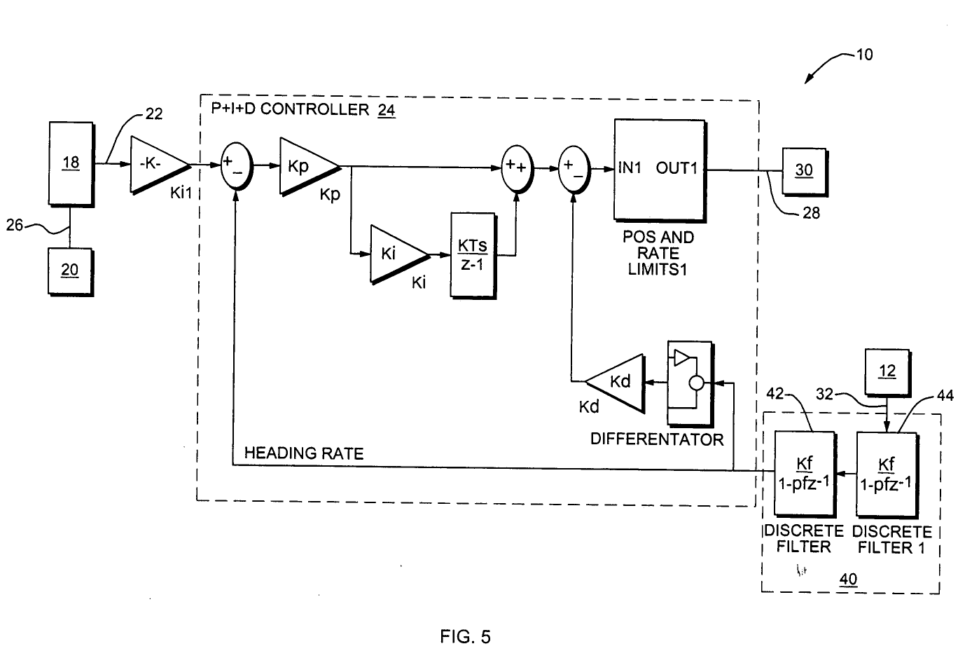

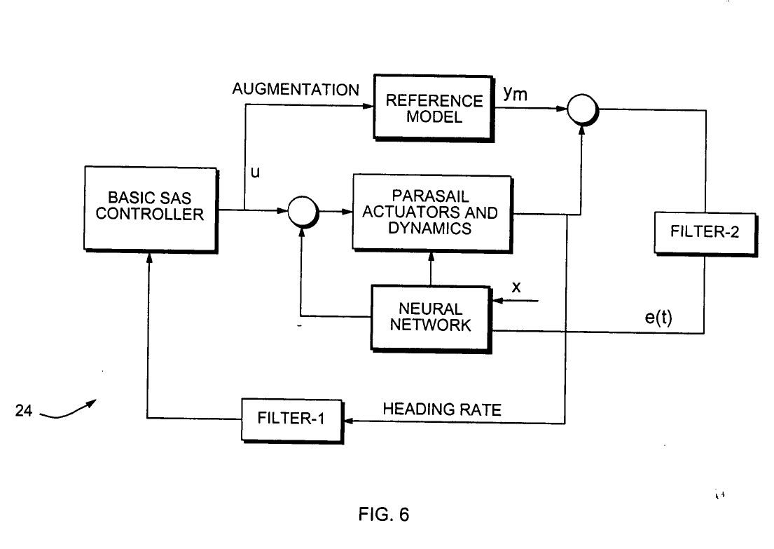

For exemplary purposes only, the SAS 24, FIG. 5, may include a Proportional+Integral+Derivative (PID) controller. Alternatively, the SAS 24, FIG. 6, may include an adaptive element that augments the PID controller in such a way so as to correct for the unknown nonlinear response characteristic of the parafoil as described in U.S. patent Ser. No. ______ (Attorney docket number Atair-034XX), filed Jul. 20, 2005 and which is also described in corresponding International Application No. PCT/US05/15679, filed May 5, 2005, which disclosure is fully incorporated herein by reference and hereinafter referred to as Ref. 2.

The role of the SAS 24 is to stabilize the air wing 14 attitude and maintain a turn rate as close as possible to the value computed as necessary and commanded by the guidance command unit 18.

As discussed above, the accuracy of current GU systems is limited as current GU systems can only control an air wing, such as a parafoil, under very docile flight conditions, i.e., very slow, flat turn rates. With parafoils, the bank angle and rate of descent are linked to turn rate. The angular rate of turn versus the control input of a parafoil is linear only over a short range. High performance turn rates create a severe problem for existing GU systems and result in out-of-control flight due to the highly nonlinear response of the parafoil at higher turn rates.

The SAS 24, FIG. 4, addresses this problem by comparing the angular rate of turn 32 computed by the AHRS or IMU 12 with the turn rate command 22 requested by the guidance command unit 18. As described above, however, the angular rate of turn signal 32 is “corrupted” by the presence of oscillations due to the non-rigid supports 16, 17.

The present invention solves this problem by including a filter 40 that filters out the oscillations present in the output 32 of the AHRS or IMU 12 (i.e., the angular turn rate) prior to processing by the SAS 24. The filter 40 may include any design known to those skilled in the art including linear and non-linear filters 40. For illustrative purposes only, the filter 40, FIG. 5, may take the form of one or more first order filters (preferably two cascading first order filters 42, 44). The filters 42, 44 preferably have identical characteristics, though this is not a limitation of the present invention unless specifically claimed as such.

The use of two first order filters 42, 44 provides a roll off at high frequencies of approximately 40 db/decade. The corner or “roll-off” frequency is the frequency beyond which signals are attenuated by the filter 40 and must be chosen such that the higher frequencies (where the oscillations are typically located) are attenuated while the lower frequencies (which are the desired signal range typically used to calculate the angular turn rate) are allowed to pass. If the corner frequency is too high then the portion of the oscillations allowed to pass through will be excessive. Alternatively, if the corner frequency is too low then performance of the SAS is reduced.

In the preferred embodiment, the gain (kf=1−pf) of the filter 40 is chosen to ensure that the low frequency gain equals 1.0. The filter pole (pf) in discrete time is related to the filter time constant by pf=exp(−dt/tauf), where dt is the sample rate period (typically 0.05 seconds) and tauf is the filter time constant (typically 0.457 seconds). The filter time constant is chosen such that 1/tauf, the corner frequency, is below the fundamental frequency of the oscillation in the suspension system 16, 17, and above the bandwidth of the SAS design 24.

A limitation of this design approach is that the bandwidth of the SAS 24 is limited by the phase shift introduced by the digital filtering of the turn rate signal 32. According to another embodiment, the present invention addresses this limitation by removing the oscillation in the turn rate signal 32 while introducing minimal phase shift. An example of one such filter 40 is described in Ibrir, S., Diop, S., “A Numerical Procedure for Filtering and Efficient High-Order Signal Differentiation,” Int. J. Appl. Math. Comput. Sci., Vol. 14, No. 2, 2004, pp. 201-208, which is fully incorporated herein by reference.

As discussed above, the SAS 24 may be of any design known to those skilled in the art. However, it is preferable to modify the PID SAS 24 design shown and described above in order to more fully address the effect of nonlinearity in the parafoil response to actuation. For example, Ref. 2 describes an adaptive system/process 24, FIG. 6 used to account for the unknown nonlinear response characteristic of the parafoil 14. The response characteristics of the parafoil 14 are highly dependent on wing loading that, in most applications, is not known beforehand.

The process of designing the adaptive element also requires special treatment of the effect of the oscillations introduced by the suspension system 16, 17, so as to prevent the adaptive process from responding excessively to these oscillations. FIG. 6 depicts one embodiment of the architecture of the adaptive SAS 24 described in Ref. 2. In this figure, a reference model is depicted. The role of the reference model is to provide an indication of the desired response (turn rate) of the parafoil 14. This desired response is compared with the measured response to create an error signal (e(t)), which is used as a teaching signal in training the weights of a Neural Network (NN). The output of the NN is used to correct the output of the basic SAS controller, previously depicted in FIG. 5. This is the process by which the effect of the nonlinear parasail 14 is learned and compensated for during flight thereby taking into account whatever wing loading is present. According to the preferred embodiment, a second filter (Filter-2), as shown in FIG. 5, is introduced. Filter-2 is substantially identical in form to the first filter (Filter-1) as previously described for FIG. 5, although again, this is not a limitation of the present invention unless otherwise specifically claimed as such.

The method 200, FIG. 2, of providing a filtered guidance signal in accordance with one aspect of the present invention begins by receiving an angular rate signal 32 from one or more sensors 12 (preferably an AHRS), act 210, that includes unwanted oscillations as a result of the suspension system 16, 17. One or more filters 40 attenuate and generally remove the oscillations present in the angular rate signal 32 that are detected by the sensor 12, act 220. The guidance command unit 18 receives a signal 26 from sensor 20 (preferably a GPS receiver or the like) and generates a commanded turn rate signal 26, act 230. The commanded turn rate signal 26 and the filtered angular rate signal 50 are then processed, act 240, by the SAS 24 to produce an actuator command signal 28. One or more actuators/servos execute the actuator command signal 28, act 250, such that the attitude of the air wing 14 substantially follows the desired command heading.

As mentioned above, the present invention is not intended to be limited to a system or method which must satisfy one or more of any stated or implied object or feature of the invention and should not be limited to the preferred, exemplary, or primary embodiment(s) described herein nor limited by choice of words such as air wing or the like. The foregoing description of a preferred embodiment of the invention has been presented for purposes of illustration and description. It is not intended to be exhaustive or to limit the invention to the precise form disclosed. Modifications or variations are possible in light of the above teachings. The embodiment was chosen and described to provide the best illustration of the principles of the invention and its practical application to thereby enable one of ordinary skill in the art to utilize the invention in various other embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A method of guiding an aircraft comprising the acts of:
receiving at least one signal indicative of an angular rate of turn of said aircraft from at least one sensor non-rigidly suspended from an air wing, said at least one signal including an oscillation component and an angular rate of turn component;
filtering said at least one signal to attenuate said oscillation present in said at least one signal using at least one filter;
receiving at least one commanded turn rate signal; and
processing said at least one filtered signal and said at least one commanded turn rate signal to determine an actuator command signal.

2. The method as claimed in claim 1 wherein a stability augmentation system (SAS) processes said at least one filtered signal and said at least one commanded turn rate signal to determine said actuator command signal.

3. The method as claimed in claim 2 wherein said SAS includes a Proportional+Integral+Derivative (PID) controller.

4. The method as claimed in claim 2 wherein said SAS includes an adaptive SAS.

5. The method as claimed in claim 4 wherein said adaptive SAS includes a neural network.

6. The method as claimed in claim 1 wherein said at least one filter includes at least one linear filter.

7. The method as claimed in claim 6 wherein said act of filtering includes at least two first order filters in series.

8. The method as claimed in claim 1 wherein said at least one filter is a non-linear filter.

9. The method as claimed in claim 1 wherein said act of receiving said at least one signal indicative of said angular rate of turn of said aircraft includes receiving at least one signal from an attitude and heading reference system or an inertial measurement unit.

10. The method as claimed in claim 1 wherein said act of receiving said at least one commanded turn rate signal includes receiving at least one signal from a global positioning system receiver.

11. The method as claimed in claim 1 wherein said act of receiving said at least one commanded turn rate signal includes receiving at least one signal from a source remote from said aircraft.

12. The method as claimed in claim 1 wherein said act of receiving said at least one commanded turn rate signal includes receiving at least one signal from an operator located proximate to said aircraft.

13. A guidance system for an aircraft comprising:
at least one sensor non-rigidly suspended from an air wing, said at least one sensor providing at least one signal indicative of an angular rate of turn of said aircraft, said at least one signal including an oscillation component and an angular rate of turn component;
at least one filter, receiving said at least one signal indicative of an angular rate of turn of said aircraft, for filtering said at least one signal to attenuate said oscillation component present in said at least one signal;
a guidance system, for providing at least one commanded turn rate signal; and
a stability augmentation system, receiving said at least one filtered signal and said at least one commanded turn rate signal, for processing said at least one filtered signal and said at least one commanded turn rate signal to provide an actuator command signal.

14. The system of claim 13 wherein said SAS includes a Proportional+Integral+Derivative (PID) controller.

15. The system of claim 13 wherein said SAS includes an adaptive SAS.

16. The system of claim 15 wherein said adaptive SAS includes a neural network.

17. The system of claim 13 wherein said at least one filter includes at least one linear filter.

18. The system of claim 13 wherein said at least one filter includes at least two linear filters in series.

19. The system of claim 13 wherein said at least one filter includes at least one non-linear filter.

20. The system of claim 13 wherein said attitude and heading reference system receives at least one signal from a global positioning system receiver.

21. The system of claim 13 further including at least one actuator device, coupled to said guidance system processing unit and to an air wing adjustment device, for receiving said actuator command signal and in response to said actuator command signal, for moving said actuator device from a first position to a second position, said movement of said actuator device causing movement of said air wing adjustment device for effectuating a change in said air wing flight.

22. A guidance system for an aircraft comprising:
at least one sensor, non-rigidly suspended from an air wing, said at least one sensor providing at least one signal indicative of an angular rate of turn of said aircraft, said at least one signal including an oscillation component and an angular rate of turn component;
at least one filter, receiving said at least one signal indicative of an angular rate of turn of said aircraft, for filtering said at least one signal to attenuate said oscillation component present in said at least one signal;
an attitude and heading reference system, for providing at least one commanded turn rate signal;
a guidance system processing unit including a stability augmentation system (SAS), receiving said at least one filtered angular rate of turn signal and said at least one commanded turn rate signal, for processing said at least one filtered signal and said at least one commanded turn rate signal to provide an actuator command signal; and
at least one actuator device, coupled to said guidance system processing unit and to an air wing adjustment device, for receiving said actuator command signal and in response to said actuator command signal, for moving said actuator device from a first position to a second position, said movement of said actuator device from said first to said second position causing movement of said air wing adjustment device for effectuating a change in said air wing flight.

23. The guidance system of claim 22 wherein said air wing includes a parafoil and wherein said air wing adjustment device includes a plurality of parafoil lines.
